(19) United States
(12) Patent Application Publication
(10) Pub. No.: US 2007/0080788 A1
(43) Pub. Date: Apr. 12, 2007

(54) System and method for slaves in a master-slave wireless network to dynamically develop affinity to a time slot

(75) Inventors: Jathan W. Manley, Blaine, MN (US); Brian VanVoorst, Minneapolis, MN (US); Robert C. Becker, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/248,120

(22) Filed: Oct. 12, 2005

(51) Int. Cl. H04Q 5/22

(52) U.S. Cl. 340/10.33; 370/458

(57) ABSTRACT

A method to dynamically schedule communication between a master and slaves in a variable slave population in a master-slave wireless network. The method includes receiving a first interrogation phase command signal from the master, transmitting a response signal to the master responsive to the first interrogation phase command signal after a current time interval, the current time interval based on a current time slot selection, receiving an acknowledgment list from the master responsive to the transmitted response signal, determining whether the current time slot selection matches a master-filled time slot based on the acknowledgement list, and modifying an affinity value based on the determination.

### TECHNICAL FIELD

The present invention relates generally to preventing data collisions in a master-slave network and in particular to preventing data collisions and reducing power consumption in a master-slave wireless network using communication slot affinity.

### BACKGROUND

In current master-slave wireless network used for inventory tracking systems, the slave population is often unknown or weakly known by the master since the slave population changes over time. An exemplary master-slave wireless network is a radio frequency identification (RFID) system. In an RFID system, the master is an RFID reader and the slave is an RFID tag attached to an object. RFID systems are used to track inventory, in which each tracked item in the inventory population has an attached active RFID tag. The inventory population changes over time as items are shipped out and as new items are brought into the system. Thus, the inventory varies and is completely changed within a timeframe that depends on the rate of sales or rate of use of the inventory.

To track the inventory in an RFID system, the RFID reader periodically interrogates the slaves by broadcasting a command signal to prompt a response from the RFID tags on the inventory located within the range of the RFID reader's command signal. When the RFID tags in the inventory population receive the initial interrogation command signal from the RFID reader, they power up and transmit an identifying response to the RFID reader. In a slot-based protocol system, the RFID tags each communicate in a self-selected time slot that is desirably a unique slot, identified by an integer for each RFID tag. The RFID tags respond to the interrogation prompt after a time delay equal to the time slot integer times the time slot duration. It is possible that two or more RFID tags may select the same slot time. In that case, the response signals from the RFID tags collide and the RFID reader does not recognize either of the response signals. In order to maximize the accuracy of the inventory taken by the RFID reader, the inventory is typically interrogated multiple times in close succession. In some master-slave wireless networks, the RFID reader recognizes the collisions and re-interrogates the inventory population of RFID tags and the RFID tags retransmit their identifying response. In other systems, the RFID reader may enumerate the empty time slots, including those where collisions occurred, transmit a list of those empty slots, and the RFID tags that did not receive an acknowledgement of having been read would attempt to reduce collisions future collisions by randomly selecting a new time slot from the transmitted list. In most implementations, the RFID reader may need to re-interrogate the inventory population many times during the interrogation event in order to receive a high percentage of correct responses.

With every interrogation event, a portion of the fixed power source in the active RFID tag is consumed. The power remaining in the RFID tag's power source decreases with the ON time of the RFID tag during each interrogation event and with the number of interrogation prompts to which the RFID tag must respond during each interrogation event.

The time between interrogation events depends on the type of tracked inventory and how quickly the inventory population is completely replaced. For example, if the inventory consists of items that are stored for an extended time, such as years, the inventory could be interrogated once every week. If the inventory population is highly dynamic and is completely replaced every few days, then the inventory may be interrogated every 30 minutes. The RFID tags, which receive frequent interrogation events and/or that receive multiple interrogation prompts per interrogation event, require a power source that is large enough to function for the duration of their expected tracked time in inventory. However, larger power sources increase the size and cost of each RFID tag and thereby increase the total system cost.

For the reasons stated above, there is a need to reduce the number and duration of interrogation prompts per interrogation event in order to reduce the cost of the master-slave wireless networks.

### SUMMARY OF THE INVENTION

One aspect of the present invention provides a method to dynamically schedule communication between a master and slaves in a variable slave population in a master-slave wireless network. The method includes receiving a first interrogation phase command signal from the master, transmitting a response signal to the master responsive to the first interrogation phase command signal after a current time interval, the current time interval based on a current time slot selection, receiving an acknowledgment list from the master responsive to the transmitted response signal, determining whether the current time slot selection matches a master-filled time slot based on the acknowledgement list, and modifying an affinity value based on the determination.

Another aspect of the present invention provides a system to dynamically schedule communication between a master and a slave in a variable slave population in a master-slave wireless network. The system includes means for determining an initial time slot selection for the slave, means for establishing an affinity value for the slave, means for establishing a current time slot selection for the slave and means for dynamically re-establishing the affinity value and the current time slot selections for the slave as the slave population changes.

Another aspect of the present invention provides a computer readable medium storing a computer program. The medium includes computer readable code for receiving a first interrogation phase command signal from the master computer readable code for transmitting a response signal to the master after a current time interval, computer readable code for receiving an acknowledgement list from the master, computer readable code for determining whether the current time slot selection matches a master-filled time slot and computer readable code for modifying an affinity value based on the determination.

The above mentioned problems of current systems are addressed by embodiments of the present invention and will be understood by reading and studying the following specification.

### BRIEF DESCRIPTION OF THE DRAWINGS

The present invention can be more easily understood and further advantages and uses thereof more readily apparent, when considered in view of the description of the embodiments and the following figures, in which like references indicate similar elements, and in which:

FIG. 1 is a block diagram of an example of an interrogation event for the master-slave wireless network of FIGS. 3A-3D in accordance with the present invention;

FIG. 2 is a block diagram of an interrogation phase within the interrogation event of FIG. 1;

FIGS. 3A-3D are block diagrams of an embodiment showing communication between the master and slaves during different time slots of the interrogation event of FIG. 1;

FIGS. 4A and 4B are an embodiment of a method of dynamically scheduling communication between a master and a slave in the master-slave wireless network of FIG. 1 in accordance with the present invention;

FIG. 5 is an embodiment of a method of communicating a first interrogation phase between a master and a slave in the master-slave wireless network of FIG. 1 in accordance with the present invention;

FIG. 6 is an embodiment of a method to modify an affinity value;

FIG. 7 is a method of modifying an affinity value in accordance with a first embodiment of the present invention;

FIG. 8 is a method of modifying an affinity value in accordance with a second embodiment of the present invention;

FIG. 9 is a method of modifying an affinity value in accordance with a third embodiment of the present invention;

FIG. 10A is a block diagram of an embodiment showing the list of all time slots and the list of unused time slots;

FIG. 10B is a mapping matrix correlating the list of unused time slots to the list of all time slots;

FIG. 11 is a method of modifying a current time slot selection in accordance with a third embodiment of the present invention; and

FIG. 12 is a method of modifying an affinity value in accordance with a fourth embodiment of the present invention.

### DETAILED DESCRIPTION

In the following detailed description, reference is made to the accompanying drawings, which form a part hereof, and in which is shown by way of illustration specific embodiments in which the invention may be practiced. These embodiments are described in sufficient detail to enable those skilled in the art to practice the invention. The following detailed description is not to be taken in any limiting sense and the scope of the present invention is defined only by the claims and equivalents thereof.

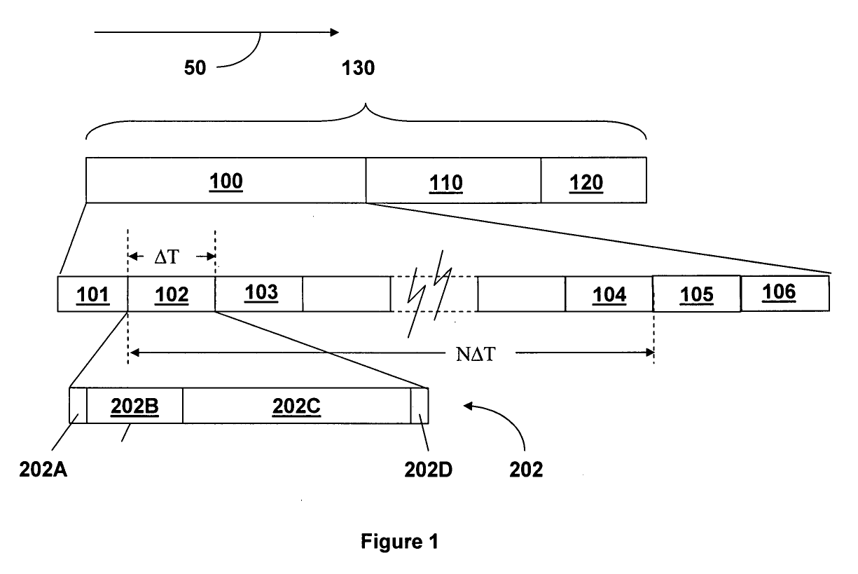

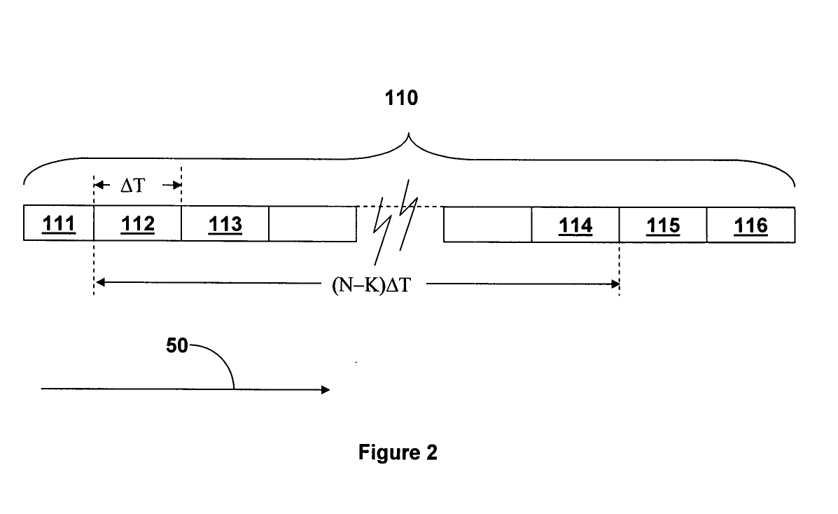

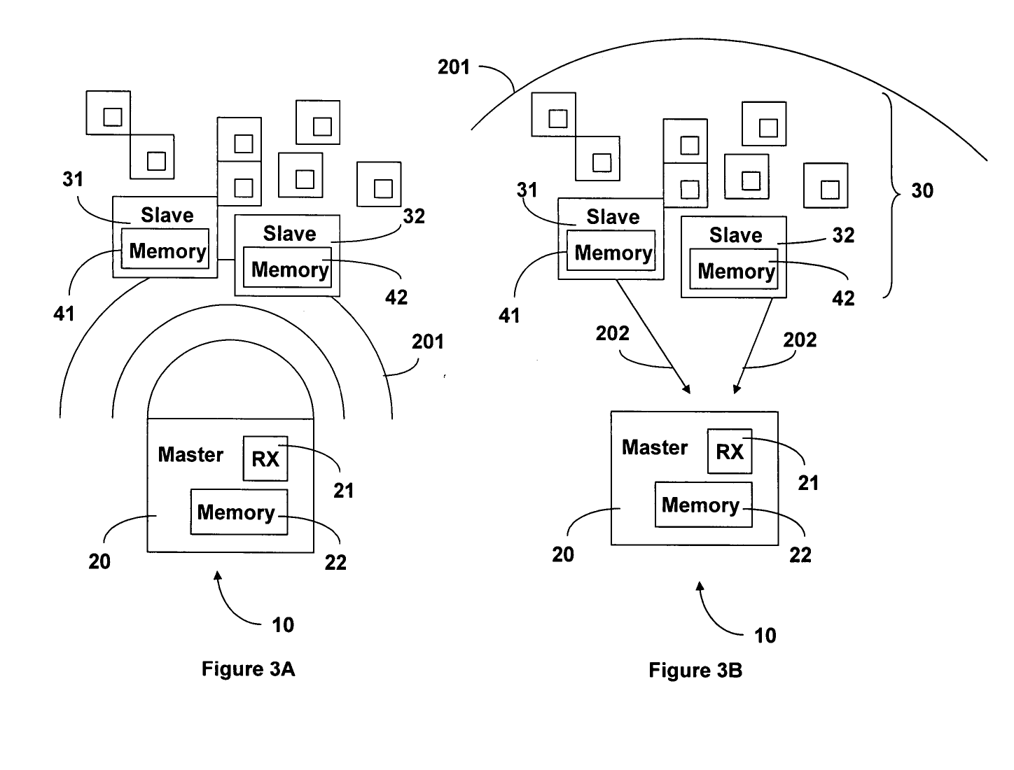

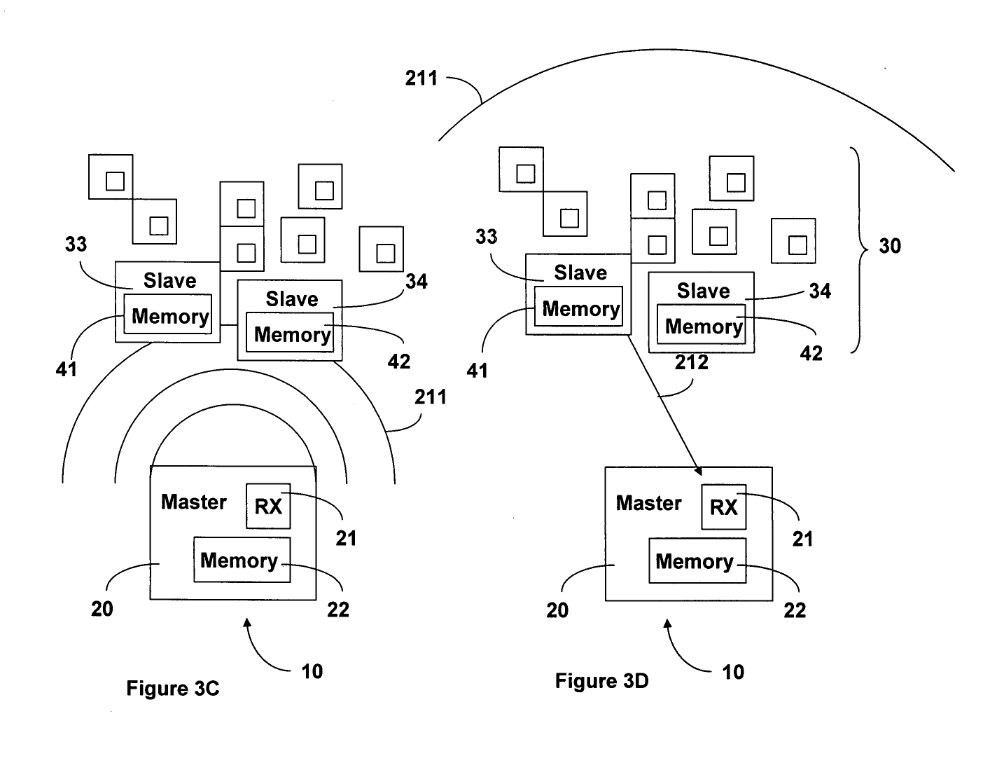

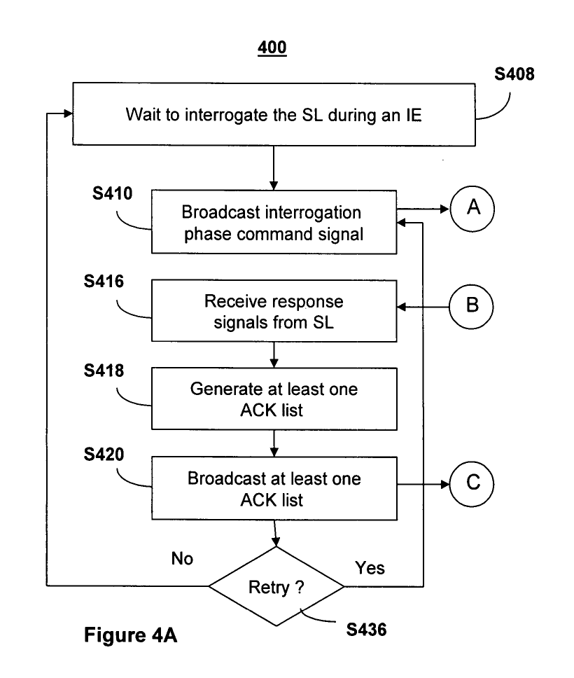

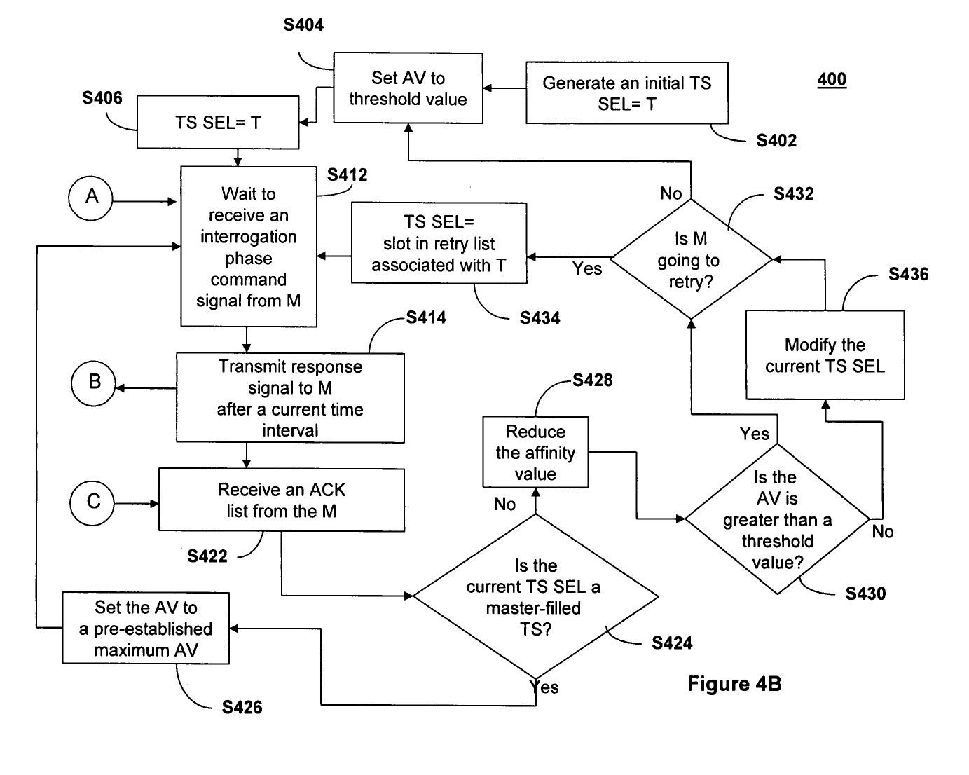

FIGS. 1, 2 and 3A-3D illustrate the components of a master-slave wireless network and the timing of a communication flow for an interrogation event based on a time-slot-based protocol for an embodiment of the present invention. FIGS. 4-9 illustrates several embodiments of the present invention based on the system described in FIGS. 1, 2 and 3A-3D. The timing of the communication between the master 20 (FIGS. 3A-3D) and the slave 31 (FIGS. 3A-3D) in the master-slave wireless network 10 (FIGS. 3A-3D) and the functionality of the various components is understandable in light of the description related to FIGS. 1, 2, 3A-3D. Specifically, the description referenced to FIG. 1 relates to the master-slave wireless network 10 as shown in FIGS. 3A-3B and the description referenced to FIG. 2 relates to the master-slave wireless network 10 as shown in FIGS. 3C-3D.

FIG. 1 is a block diagram of an example of an interrogation event 130 for the master-slave wireless network 10 of FIGS. 3A-3D in accordance with an embodiment of the present invention. FIG. 2 is a block diagram of an interrogation phase 110 within the interrogation event 130 of FIG. 1. FIGS. 3A-3D are block diagrams of an embodiment showing communication between the master 20 and slaves 31 and 32 during different time slots of the interrogation event 130 of FIG. 1. The slaves 31 and 32 are exemplary slaves in the slave population 30 and the functional capability described herein for either slave 31 or slave 32 is the functional capability of all the slaves within the slave population 30. The master 20 and slaves 31 each include a transceiver (not shown) configured for a compatible network protocol. The transceiver in the slave 31 is operable to communicate with the transceiver in the master 20.

Each slave 31 determines an initial time slot upon entering the master-slave wireless network 10 as known in the art. The initially selected time slot is stored as a current time slot in a memory 41 in the slave 31. The current time slot is positive integer between 1 and N, if N is the maximum number of time slots recognized by the master 20.

Additionally, each slave 31 determines an affinity value upon entering the master-slave wireless network 10. The affinity value indicates the affinity of a slave 31 to a time slot. After a successful interrogation event 130 by the master 20, the slave 31 sets the affinity value of the currently selected time slot to a pre-established maximum affinity value. In a successful interrogation event 130, a response signal 212 (FIG. 3D) from the slave 31 is received and stored in memory 22 by the master 20.

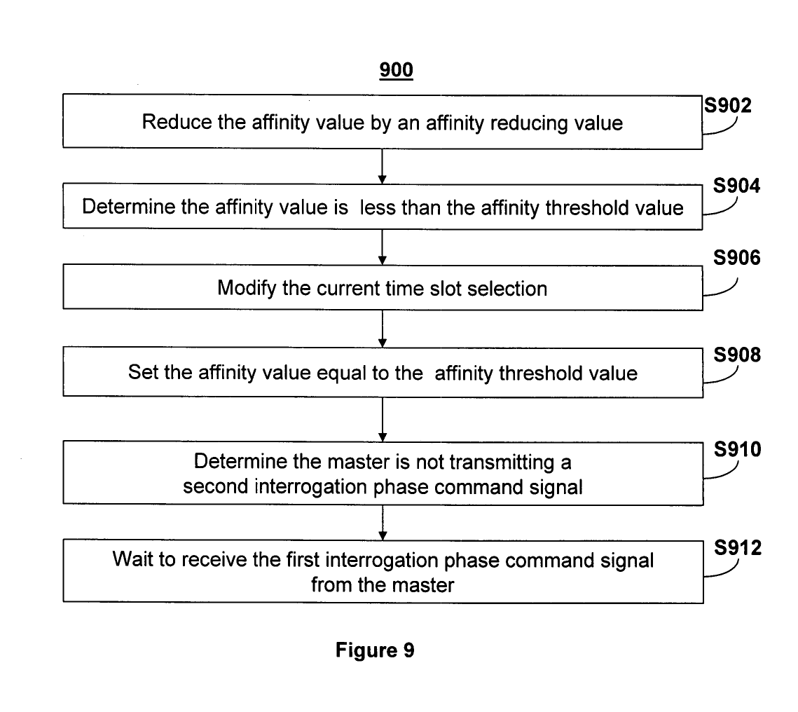

After an unsuccessful interrogation event 130 by the master 20, the slave 31 decreases the affinity to the currently selected time slot. In an unsuccessful interrogation event 130, a response signal 202 (FIG. 3B) from the slave 31 is not received by the master 20. After the affinity value of the slave 31 decreases to an affinity threshold value, the slave 31 selects a new current time slot as described below with reference to stage S906 of method 900 in FIG. 9. The affinity value is stored in a memory 41 in the slave 31. Each slave 31 is positioned within the broadcasting range of the master 20 upon entering the master-slave wireless network 10.

Referring now to FIG. 1, an exemplary interrogation event 130 includes a first interrogation phase 100, a second interrogation phase 110 and a third interrogation phase 120. The time slots of the first interrogation phase 100, the second interrogation phase 110 and the third interrogation phase 120 are represented as boxes. The length of a box representing a time slot is parallel to the arrow 50. Arrow 50 indicates the direction in which time unfolds. Within this document and drawings, the relative lengths of boxes that represent time slots indicate the relative time duration for the communication taking place during that time slot. Likewise, within this document and drawings, the relative positions of boxes that represent time slots indicate the relative timing for the communication taking place during that time slot. Specifically, the left edge of the box indicates the start time for the communication taking place during that time slot and the right edge of the box indicates the end time for the communication taking place during that time slot.

Thus, the first interrogation phase 100 occurs before the second interrogation phase 110 and the second interrogation phase 110 occurs before the third interrogation phase 120. The duration of third interrogation phase 120 is less than the duration of second interrogation phase 110. The duration of the second interrogation phase 110 is less than the duration of first interrogation phase 100. The interrogation phases 100, 110 and 120 include sequential time slots 101-106 of about equal duration ΔT.

The interrogation phase 100 is shown in an exploded view in FIG. 1. The time slot 101 is the first time slot of the first interrogation phase 100. FIG. 3A shows the master-slave wireless network 10 during the time of time slot 101. During the first time slot of every interrogation phase, the master 20 broadcasts interrogation phase command signals to the slave population 30. FIG. 3A shows wave fronts of an electro-magnetic interrogation phase command signal 201. The interrogation phase command signal 201 was transmitted by the master 20 and is propagating towards the slave population 30 during the time of time slot 101.

During the subsequent N time slots 102-104, the master 20 is in a response-received mode. If the master 20 recognizes that there are N slaves 31 in the slave population 30, the master 20 waits the duration of N time slots to receive the response signals. Thus, as shown in FIG. 1, the duration of the response-received mode for the master 20 for the first interrogation phase 100 equals NΔT. In some embodiments, the master 20 determines that the number of slaves 31 in the slave population 30 is approximately N, but the master 20 does not know the exact value since slaves 31 are added to and removed from the master-slave wireless network 10 without any input to the master 20.

FIG. 3B shows the master-slave wireless network 10 during the time of time slot 102. The interrogation phase command signal 201 that was broadcast to the slave population 30 during time of time slot 101 has passed the slave population 30. During the time of time slot 102, slave 31 and slave 32 both transmit a response signal 202 to the master 20. FIG. 1 shows the protocol-based content of response signal 202 in an exploded view, wherein the content is represented by time slots during which the content is transmitted from the slave 31 to the master 20. Response signal 202 includes sequentially received first guard 202A, a message header 202B, a message payload 202C, and a second guard 202D. The message payload 202C identifies the slave 31 that sent the response signal 202 during time slot 102. The message header 202B includes the address for the master 20. The first guard 202A and the second guard 202D allow for inaccuracies in the timing between the slaves 31 in the slave population 30 to prevent undesired collisions between slaves 31 responding during sequential time slots. In one embodiment, the response signal 202 includes additional information required by the master-slave wireless network protocol.

In the case illustrated in FIG. 3B, slave 31 and slave 32 each select time slot 102. The master 20 does not recognize either the response signal 202 from slave 31 and or the response signal 202 from slave 32 because the response signals 202 collide at the master 20 creating noise at the receiver 21 of the master 20. Such time slots are master-contended time slots. Master-contended time slots are a subset of the master-open time slots. A time slot is defined herein as a master-open time slot if the data from the message payload 202C of the response signal 202 from a slave 31 is not stored by the master 20 in a memory 22 located in the master 20 during the duration of the time slot. Thus in this exemplary case of FIG. 3B, time slot 102 becomes a master-open time slot. The master 20 stores data to indicate the time slot 102 is an open time slot in the memory 22.

In one embodiment, the memory 22 is located external to the master 20. In another embodiment, only slave 31 transmits a response signal 202 during time slot 102. In this case, only slave 31 has selected time slot 102 and the master 20 receives and recognizes the response signal 202 and time slot 102 becomes a master-filled time slot. A time slot is defined herein as a master-filled time slot if the data from the message payload 202C of the response signal 202 from the slave 31 is stored by the master 20 in memory 22 during the duration of the time slot.

In yet another embodiment, no slaves 31 transmit a response signal 202 during time slot 102. If the master 20 does not receive a response signal 202 from any slave 31 during the duration of the time slot, the time slot is a master-quiet time slot. Master-quiet time slots are a subset of the master-open time slots.

If the master 20 fails to receive a response signal 202 sent from a slave 31, the time slot is a receive-failed time slot. Receive-failed time slots are a subset of the master-open time slots. The master 20 fails to receive the response signal 202 if there are errors in the response signal 202. Additionally, the master 20 fails to receive the response signal 202 if there are errors in the master's transceiver.

Time slot 102 is the first time slot during the response-received mode and the second time slot of the first interrogation phase 100. Time slot 103 is the second time slot during the response-received mode and the third time slot of the first interrogation phase 100. Time slot 104 is the N^{th} time slot during the response-received mode and the (N+1) time slot of the first interrogation phase 100. Time slot 104 is the last time slot of the response-received mode of the first interrogation phase 100. As used herein, N is a positive integer.

The time slot 105 is the second-to-last time slot of the first interrogation phase 100. The second-to-last time slot of every interrogation phase is the time during which the master 20 broadcasts an acknowledgement list to the slave population 30 responsive to the response signals 202 received from the slave population 30 during the response-received mode of the first interrogation phase. The acknowledgement list is a list of master-filled time slots. Other types of acknowledgement lists are possible. The acknowledgement includes one or more of the list of master-filled time slots, the list of master-open time slots, the list of receive-failed time slots, the list of master-contended time slots, and the list of master-quiet time slots. The slaves 31 include protocol and computer programmable media required to recognize whether the acknowledgement list is the set open time slots, a subset of open time slots or the set of filled time slots.

The time slot 106 is the last time slot of the first interrogation phase 100. The last time slot of every interrogation phase is the time during which the master 20 broadcasts a list of master-open time slots to the slave population 30 responsive to the signal responses 202 received from the slave population 30 during the response-received mode of the first interrogation phase 100. The combined acknowledgement list that includes master-filled time slots and the list of master-open time slots include all the time slots from 102 through 104.

In one embodiment, the time slot 105 is the last time slot of the first interrogation phase 100 and the list of master-open time slots is not broadcast to the slave population 30. In another embodiment, the list of master-open time slots is transmitted during time slot 105 and the acknowledgement list of master-filled time slots is not broadcast to the slave population 30. In one embodiment, the slaves 31, which have selected a time slot that was listed in a master-filled acknowledgement list, power OFF their power sources list to reduce power consumption after recognizing that their selected time slot was in the master-filled acknowledgement. In another embodiment, the slaves 31, which have a selected time slot that was not listed in a master-open acknowledgement list, power OFF their power sources to reduce power consumption after recognizing that their selected time slot was not listed in a master-open acknowledgement list.

In one embodiment of an interrogation event, subsequent interrogations phases follow the second interrogation phase 120 until the all time slots in an acknowledgment list are master-filled time slots, and wherein each subsequent interrogation phase is of shorter duration than the previous interrogation phase.

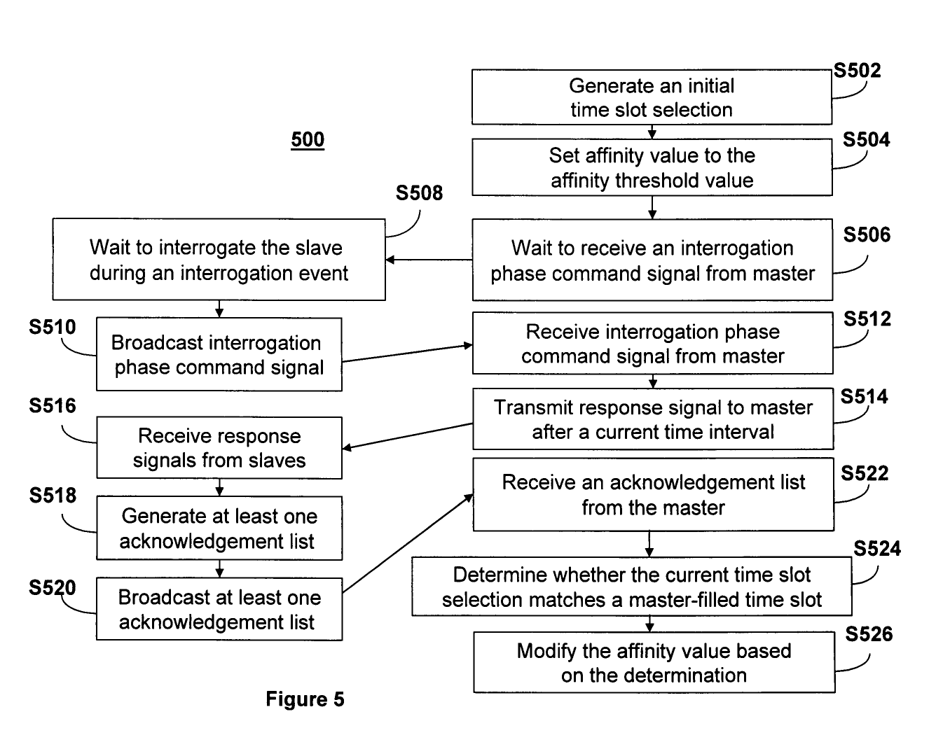

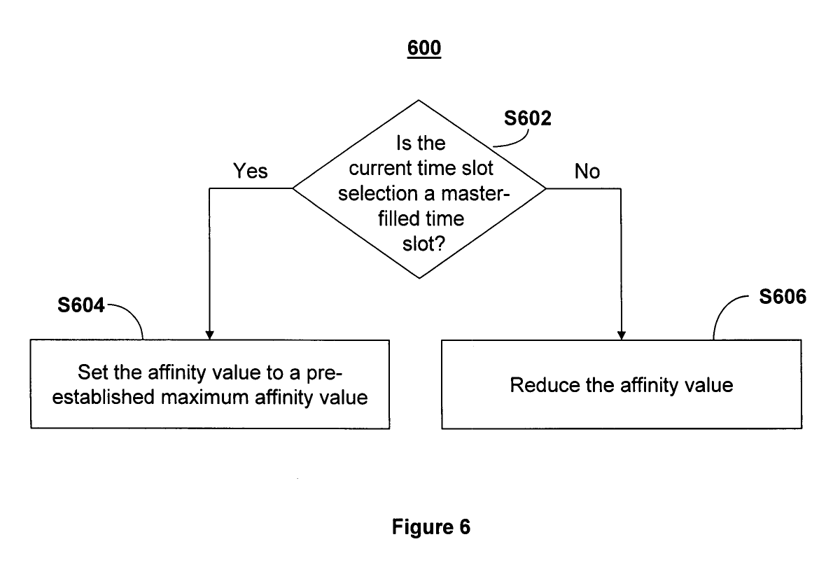

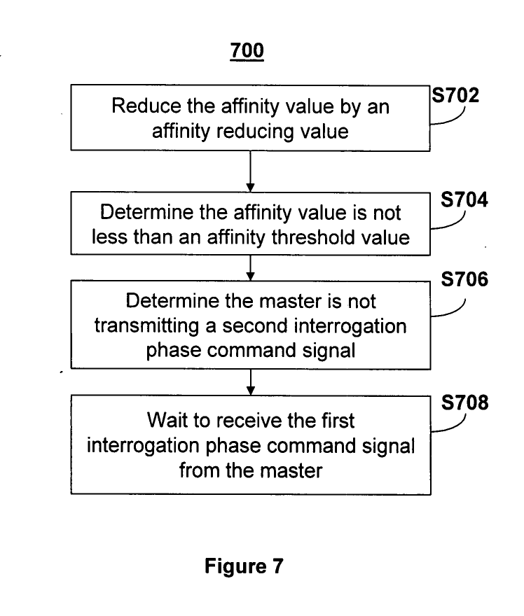

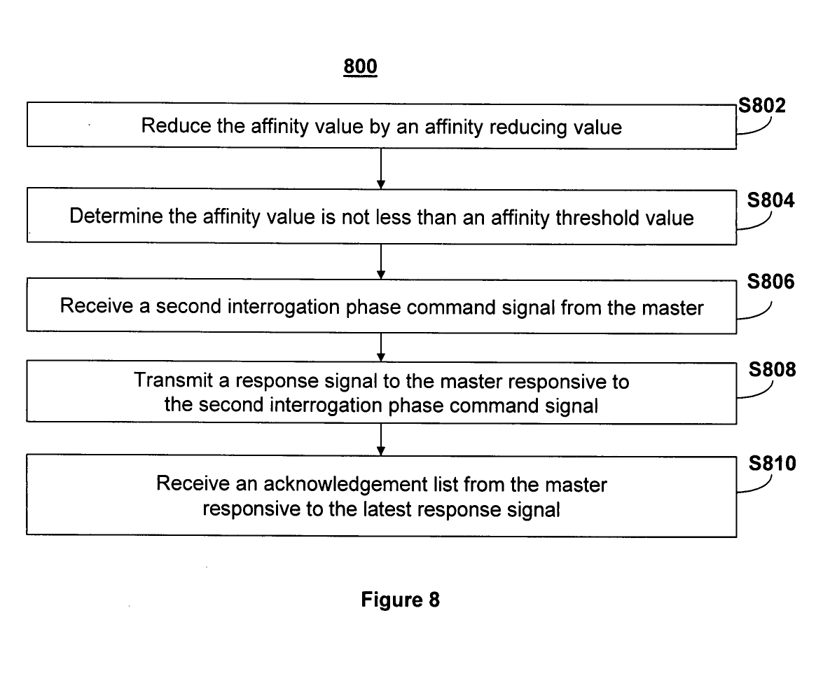

The affinity value of the slave 31 is modified if the acknowledgement list indicated that message payload 202C of slave 31 was not stored in memory 22. A slave 31 having a modified affinity value is represented as slave 33 (FIG. 3C-3D). A slave 32 having a modified affinity value is represented as slave 34 (FIG. 3C-3D). The modified affinity value is stored in the memory 41 of slave 33 and the memory 42 of slave 34. Various embodiments for modifying slave 31 are described below with reference to FIGS. 5-9. In some embodiments as described below with reference to FIGS. 8 and 9, the modified affinity value is used by the slaves 33 and 34 to modify their respective time slot selections from the initial time slot selection to a current time slot selection. In other embodiments as described below with reference to FIGS. 6 and 7, the slaves 33 and 34 keep the initial time slot selection as the current time slot selection.

FIG. 2 illustrates an expanded view of an exemplary second interrogation phase 110 of interrogation event 130. The second interrogation phase 110 includes sequential time slots of about equal duration ΔT. The time slot 111 is the first time slot of the second interrogation phase 110. FIG. 3C shows the master-slave wireless network 10 during the time of time slot 111. During the time of time slot 111, the interrogation phase command signal 211 propagates towards the slave population 30. The slave population 30 now includes the slave 33 and slave 34 which each include modified affinity values. During the subsequent (N−K) time slots 112-114, the master 20 is in the response-received mode as described above with reference to FIG. 3A. As used herein, K is a positive integer having a value less than the value of N.

At the start of the second interrogation phase 110, the master 20 recognizes that K time slots of the available N time slots were filled during the response-received mode of the first interrogation phase 100 (FIG. 1) based on the generated acknowledgement list and the knowledge that there are N slaves in the slave population 30. As shown in FIG. 2, the duration of the response-received mode for the master 20 for the second interrogation phase 110 equals (N−K)ΔT since the master 20 only waits the duration of (N−K) time slots while the (N−K) slaves 33 respond during the second interrogation phase 110. Since (N−K) slaves 33 take (N−K)ΔT to respond, the duration of the response-received mode of second interrogation phase 110 is shorter than the duration of the response-received mode of first interrogation phase 110 by KΔT.

The modified (N−K) slaves 33 retransmit a response signal 212 during one of the time slots in the response-received mode of the second interrogation phase 110. The modified (N−K) slaves 33 determine when to transmit response signal 212 as described below with reference to stage S906 of method 900 in FIG. 9.

FIG. 3D shows the master-slave wireless network 10 during the time of time slot 112. The interrogation phase command signal 211 that was broadcast to the slave population 30 during time of time slot 111 has passed the slave population 30. During the time of time slot 112, slave 33 transmits a response signal 212 to the master 20. The current time slot selection of slave 34 is not the same as the current time slot selection for slave 33 so the slave 34 does not transmit a response signal 212 to the master 20 during time slot 112. Thus during time slot 112, there is no collision of response signal 212 transmitted from the slave 33. Barring an error in the master 20 and the response signal 212, the master 20 receives the response signal 20 at the time slot 112. The response signal 212 transmitted by the slave 33 is formatted in the manner described above with reference to response signal 202 of FIG. 1.

The third interrogation phase 120 experiences a like reduction in duration of response-received mode. In some embodiments of the present invention, the affinity value for each slave 31 in the slave population 30 reduces the duration of the response-received mode for each subsequent response-received mode, as is apparent from the discussion related to FIGS. 4-9.

Time slot 112 is the first time slot during the response-received mode and the second time slot of the second interrogation phase 110. Time slot 113 is the second time slot during the response-received mode and the third time slot of the second interrogation phase 110. Time slot 114 is the (N−K)^{th} time slot during the response-received mode and the (N−K+1)^{th} time slot of the second interrogation phase 110. Time slot 114 is the last time slot of the response-received mode of the second interrogation phase 110.

The time slot 115 is the second-to-last time slot of the second interrogation phase 110. The second-to-last time slot of every interrogation phase is the time during which the master 20 broadcasts an acknowledgement list as described above with reference to FIG. 1. The time slot 116 is the last time slot of the second interrogation phase 110 during which the master 20 broadcasts a list of master-open time slots as described above with reference to FIG. 1.

In one embodiment, the time slot 115 is the last time slot of the second interrogation phase 110 and the list of master-open time slots is not broadcast to the slave population 30. In another embodiment, the list of master-open time slots is transmitted during time slot 115 and the list of master-filled time slots is not broadcast to the slave population 30. In yet another embodiment, the slaves 33, which have a selected time slot that was listed in the acknowledgement list, power OFF their power sources to reduce power consumption after recognizing that their selected time slot was in the master-filled acknowledgement.

In one embodiment, this master-slave wireless network 10 is an RFID master-slave wireless network. In this case, the master 20 is an RFID reader and the slaves 31 are RFID tags within the range of a radio frequency signal broadcast by the RFID reader.

FIGS. 4A and 4B are an embodiment of a method 400 of dynamically scheduling communication between a master 20 and a slave 31 in the master-slave wireless network 10 of FIG. 1 in accordance with the present invention. Many paths are possible in the flowchart representing method 400. To clarify the description of method 400, the possible path flows are outlined as methods 500-100 of FIGS. 5-10, respectively, and discussed independently. Thus, the methods 500-1000 described with reference to FIGS. 5-10, respectively, together provide details of the methods for scheduling communication between a master and slaves in a variable slave population in a master-slave wireless network. The slaves within the slave population include hardware and computer readable medium storing a computer program operable to perform the functions described with reference to methods 400-1000. The methods 400-1200 are described with reference to the exemplary master-slave wireless network 10 described above with reference to FIGS. 1, 2 and 3A-3D.

In FIG. 4A, the functions of the master 10 are outlined with flow-connecting circles A, B and C to indicate an interaction with the slave 31. In FIG. 4B, the functions of the slave 31 are outlined with flow-connecting circles A, B and C to indicate an interaction with the slave 31. The following acronyms are used in method 400: SL is slave, IE is interrogation event, ACK is acknowledgement, TS is time slot, ASG is assignment, M is master, AV is affinity value, and T is a symbol representative of the current time slot.

Specifically, method 500 describes the flow in FIGS. 4A and 4B through stages S402-S424 and S436. Method 600 describes the flow in FIG. 4B through stages S424-S428. Method 700 describes the flow in FIG. 4B through stages S428, S430, S432, to S406. Method 800 describes the flow in FIG. 4B through stages S428, S430, S432, S434, S412, S414, and S422. Method 900 describes the flow in FIG. 4B through stages S428, S430, S436, S432, S404, S406, and S412. Method 1000 describes the flow in FIG. 4B through stages S428, S430, S436, S432, S434, S412, S414, and S422.

FIG. 5 is an embodiment of a method 500 of communicating a first interrogation phase 100 between a master 20 and slaves 31 in the master-slave wireless network 10 of FIG. 1 in accordance with the present invention. Method 500 additionally describes the method of initiating a slave 31 into the master-slave wireless network 10.

During stage S502, the slave 31 generates an initial time slot selection. The slave 31 includes a random number generator (not shown). When the slave 31 is entered into the master-slave wireless network 10, the random number generator generates a number within the limit N of the master-slave wireless network 10. The initial time slot selection is stored in the memory 41 of the slave 31 as the current time slot selection. During stage S504, the slave 31 sets the affinity value equal to the affinity threshold value and stores the affinity value in the memory 41 of slave 31. At this point, the slave 31 is initiated to communicate with the master 20 in the master-slave wireless network 10. In one embodiment, the affinity threshold value is the integer one. In another embodiment, the master 20 transmits the value of N to the slave 31 when the slave 31 enters the broadcast region of the master 20. In yet another case, the slave 31 has N preset in the memory 41.

During stage S506, the slave 31 waits to receive an interrogation phase command signal, such as first interrogation phase command signal 201, from the master 20. The time that the slave 31 waits between receiving the interrogation events 130 depends on the interrogation schedule of the master 20. The interrogation schedule is a function of the type of inventory and the rate of turnover in the inventory. During stage S508, the master 20 waits to interrogate the slave population 30. Stage S506 overlaps in time with stage S508. If the slave 31 has not been initiated into the master-slave wireless network 10 before the last interrogation event, then stage S506 occurs, at least in part, at about the same time as stage S508.

During stage S510, the master 20 broadcasts a first interrogation phase command signal 201, as described above with reference to FIGS. 1 and 3A. During stage S512, the slave 31 receives a first interrogation phase command signal 201 from the master 20.

During stage S514, the slave 31 transmits a response signal 202 to the master 20, as described above with reference to FIGS. 1 and 3B. Each slave 31 in the slave population 30 has their current time slot selection and their current time interval based on the current time slot selection stored in memory 41. The current time interval is the product of the current time slot selection and the time duration of each time slot. When the slave 31 receives the first interrogation phase command signal 201, the slave 31 retrieves the current time interval from memory 41. In the exemplary master-slave wireless network 10 in which the time duration of each slot is ΔT, if slave 31 has a current time slot selection F, the current time interval is FΔT. The slave 31 waits for a time duration equal to FΔT to pass and then transmits the response signal 201.

During stage S516, the master 20 is in the response-received mode. The master 20 waits for and receives the response signals 202 from one or more of the slaves 31 during the response-received mode. The master 20 receives the responses at receiver 21. The master 20 stores the message payload 202C from the slave 31 in memory 22 along with an indicator of the time slot in which the message payload 202C was received. Stage S514 and S516 partially overlap in time.

During stage S518, the master 20 generates at least one acknowledgement list after the response-received mode is over. The master 20 generates the acknowledgement list according to the protocol of the master-slave wireless network 10 as described above with reference to FIG. 1. The master 20 generates an acknowledgement list that includes the master-filled time slots. In one embodiment, the master 20 generates an acknowledgement list that includes the master-open time slots. In another embodiment, the master 20 generates an acknowledgement list that includes a concatenated list of receive-failed time slots, master-quiet time slots and the master-contented time slots.

During stage S520, the master 20 broadcasts the acknowledgement list generated during stage S518 to the slave population 30. Referencing the exemplary master-slave wireless network 10 of FIGS. 1, 2 and 3A-3D, the acknowledgement list is transmitted during the time slot 105.

During stage S522, the slaves 31 in the slave population 30 receive the acknowledgement list from the master 20. During stage S524, each slave 31 determines whether the current time slot selection stored in memory 41 matches one of the master-filled time slots in the acknowledgement list. The slaves 31 retrieve the current time slot selection from memory 41 when the acknowledgement list is received and compare the acknowledgement list to the retrieved current time slot selection. In one embodiment, each slave 31 determines whether the current time slot selection stored in memory 41 matches a time slot in the master-open time slot list. In yet another embodiment, each slave 31 determines whether the current time slot stored in memory 41 does not match a time slot in the concatenated list of receive-failed time slots, master-quiet time slots and the master-contented time slots.

During stage S526, each slave 31 modifies the affinity value based on the determination made during stage S526. The details of the determination are described below with reference to method 600 in FIG. 6.

FIG. 6 is an embodiment of a method 600 to modify an affinity value. During stage S602, each slave 31 determines whether the current time slot stored in memory 41 matches one of the master-filled time slot in the acknowledgement list as described above with reference to stage S524 of method 500 in FIG. 5.

If the determination made during stage S602 is positive, the method 600 flows to stage S604. During stage S604, the slave 31 sets the affinity value to a pre-established maximum affinity value. The pre-established maximum affinity value is stored in memory 41 and is greater than an affinity threshold value. In one embodiment, the affinity threshold value is one. The pre-established maximum affinity value was stored in memory 41 by the manufacturer of the slave 31.

If the determination made during stage S602 is negative, the method 600 flows to stage S606. During stage S606, the slave 31 reduces the affinity value. The slave 31 retrieves the affinity value from the memory 41 and stores the reduced affinity value in memory 41. Each slave's 31 affinity value is based on the pre-established maximum affinity value, an affinity reducing value and the number of times the slave 31 has made a negative determination during stage S602 since last making a positive determination during stage S602. The function of the affinity reducing value is described below with reference to stage S702 of method 100 in FIG. 7. Methods 700-1000 described below with reference to FIGS. 6-9 outline the actions of the slaves 31 based on the master-slave wireless network 10 protocols and the current affinity value of the slave 31.

FIG. 7 is a method 700 of modifying an affinity value in accordance with a first embodiment of the present invention. Method 700 applies to a slave 31 within a master-slave wireless network 10 that requires only one interrogation phase 100 per interrogation event 130 and which has experienced at least one successful interrogation event 130. In a successful interrogation event 130, the response signal 202 is received and recognized by the master 20.

During stage S702, the slave 31 reduces the affinity value by the affinity reducing value. Since the slave 31 has experienced at least one successful interrogation event the affinity value is greater than the affinity threshold value before the reduction. During stage S704, the slave 31 determines the affinity value is not less than the affinity threshold value. In one embodiment of method 700, the affinity reducing value is one and the affinity threshold value is one. During stage S706, the slave determines the master 20 is not transmitting a second interrogation phase command signal. This determination is made based on the protocol of master-slave wireless network 10 in which the slave 31 operates. The protocol indicates the number of interrogation phases the master 20 transmits in one interrogation event 130.

During stage S708, the slave 31 waits to receive the first interrogation phase command signal 210 from the master 20 as described above with reference to stage S508 during method 500 in FIG. 5. The first interrogation phase command signal 210 is scheduled to be broadcast by the master 20 at the start of the next interrogation event 130 as described above with reference to stage S510 during method 500 in FIG. 5.

FIG. 8 is a method 800 of modifying an affinity value in accordance with a second embodiment of the present invention. Method 800 applies to a slave 31 within a master-slave wireless network 10 that requires more than one interrogation phase 100 per interrogation event 130 and which has experienced at least one successful interrogation event 130.

During stage S802, the slave 31 reduces the affinity value by the affinity reducing value. Since the slave 31 has experienced at least one successful interrogation event the affinity value is greater than the affinity threshold value before the reduction. In one embodiment of method 800, the affinity reducing value is one and the affinity threshold value is one. During stage S804, the slave 31 determines the affinity value is not less than the affinity threshold value.

During stage S806, the slave 31 receives the second interrogation phase command signal 211 from the master 20. During stage S808, the slave 31 transmits a response signal 212 to the master 20 responsive to the second interrogation phase command signal 211. The slave 31 transmits the response signal 212 after waiting the current time interval. In this embodiment, the current time interval during the second interrogation phase 110 is the same duration as the current time interval of the first interrogation phase 100. They are the same since the current time slot selection has not changed. In the exemplary master-slave wireless network 10, the time duration of each slot is ΔT, the current time slot selection is F, and the current time interval is FΔT. Thus, the slave 31 waits for a time duration equal to FΔT to pass and then transmits the response signal 212.

During stage S810, the slave 31 receives an acknowledgement list from the master 20 responsive to the latest response signal 212 transmitted during stage S806. The flow of method 800 continues for a third interrogation phase 120, based the protocol of master-slave wireless network 10 and number of open-master time slots at the master 20 following the second interrogation phase 110. The flow of the third interrogation phase 120 and any additional interrogation phases proceed according to the flow of method 800, as is understandable to one skilled in the art.

FIG. 9 is a method 900 of modifying an affinity value in accordance with a third embodiment of the present invention. Method 900 applies to a slave 31 within a master-slave wireless network 10 that requires only one interrogation phase 100 per interrogation event 130 and which has experienced enough unsuccessful interrogation events 130 to drive the affinity value down to the value equal to the affinity threshold value before the first interrogation phase 100 of the current interrogation event 130.

The affinity value is driven to the value of the affinity threshold value by going through iterations of method 700. Take an exemplary case in which the affinity reducing value is one and the affinity threshold value is one and the affinity value was set to an affinity value M as described above with reference to stage S604 in method 600 of FIG. 6. If the slave 31 experienced a successful interrogation event 130 and then the slave 31 experienced (M−1) unsuccessful interrogation events 130, then slave 31 has an affinity value of one, the affinity threshold value, at the start of method 900.

In another exemplary case of method 900, the slave 31 was introduced to the master-slave wireless network and current interrogation event is the first interrogation event experienced by the slave 31 while in the master-slave wireless network 10. In this case, slave 31 has an affinity value equal to the affinity threshold value at the start of method 900.

During stage S902, the slave 31 reduces the affinity value by the affinity reducing value. During stage S904, the slave 31 determines the affinity value is less than the affinity threshold value. In one embodiment of method 900 as described above, the affinity reducing value is one and the affinity threshold value is one.

During stage S906, the slave 31 modifies the current time slot selection. The time slot selection is modified by one of many possible techniques. The master-slave wireless network 10 protocols stored in the memory 41 of the slave 31 and the memory 22 of master 20 set the modification technique. In a first embodiment of modifying the current time slot selection, the current time slot selection is randomly selected from the list of all time slots one through N. In this embodiment, the master 20 broadcasts the acknowledgement list during time slot 105 and broadcasts the list of master-open time slots during time slot 106. In this embodiment, the time slot 105 is the last time slot of the first interrogation phase 100.

In a second embodiment of modifying the current time slot selection, the slave 31 determines the current time slot selection by applying a first selection algorithm to the list of all time slots. In the first selection algorithm, the slave randomly selects a stride value from a list of preset stride values, adds the randomly selected stride value to the current time slot selection and sets the sum as the current time slot selection. Once the first selection algorithm is applied by the slave 31, the current time slot selection becomes a new current time slot selection. A stride value is a positive integer. The list of preset stride values stored in the memory 41. In one embodiment, the stride value is less than (N−K) where K is an integer less than N where N is the number of slaves 31 in the slave population 30. When the sum of the randomly selected stride value and the current time slot selection is greater than N, the current time slot assignment is wrapped around the time slot list.

In a third embodiment of modifying the current time slot selection, the slave 31 randomly selects the current time slot selection from the list of master-open time slots. In this embodiment, the master 20 has mapped a sub-list of master-open time slots to the total list of time slots. In this embodiment, the master 20 is required to broadcast the acknowledgement list during time slot 105 and to broadcast the list of master-open time slots during time slot 106. In this embodiment, the time slot 106 is the last time slot of the first interrogation phase 100.

In a fourth embodiment of modifying the current time slot selection, the slave 31 applies a second selection algorithm from a list of preset stride values to the list of unused time slots. In the second selection algorithm, the slave 31 randomly selects a stride value from a list of preset stride values, determines which of the master-open time slots is closest to the current time slot selection, determines the position of the master-open time slot that is closest to the current time slot, adds that position to the randomly selected stride value and sets the sum as the time slot selection in the list of master-open time slots. The value of the time slot in the list of master-open time slots is the new current time slot selection.

In an exemplary application of the second selection algorithm, the list of master-open time slots is 1, 4, 11, 13, 15, 16, 17, 20 and 24 while the list of preset values is 3, 5, 7 and 17. The slave 31, which has a current time slot of 8, applies the second selection algorithm and randomly selects the stride value 5. The slave 31 determines that 11 in the list of master-open time slots is closest to 8 and that 11 has selected the position of 3 in the list of master-open time slots, since only 1 and 4 precede 11 in the list of master-open time slots. The position 3 is added to the randomly selected stride value 5 to obtain the sum of 8. This sum 8 is the time slot selection in the list of master-open time slots 1, 4, 11, 13, 15, 16, 17, 20 and 24. The eighth digit in the list of master-open time slots is 20. Thus, 20 is the new current time slot selection. The slave 31 will wait for a time of 20ΔT after receiving the second interrogation phase command signal and then send the response signal 202 to the master 20. Once the second selection algorithm is applied by the slave 31 the current time slot selection becomes a new current time slot selection. In this embodiment, the master 20 is required to broadcast the acknowledgement list during time slot 105 and to broadcast the list of master-open time slots during time slot 106.

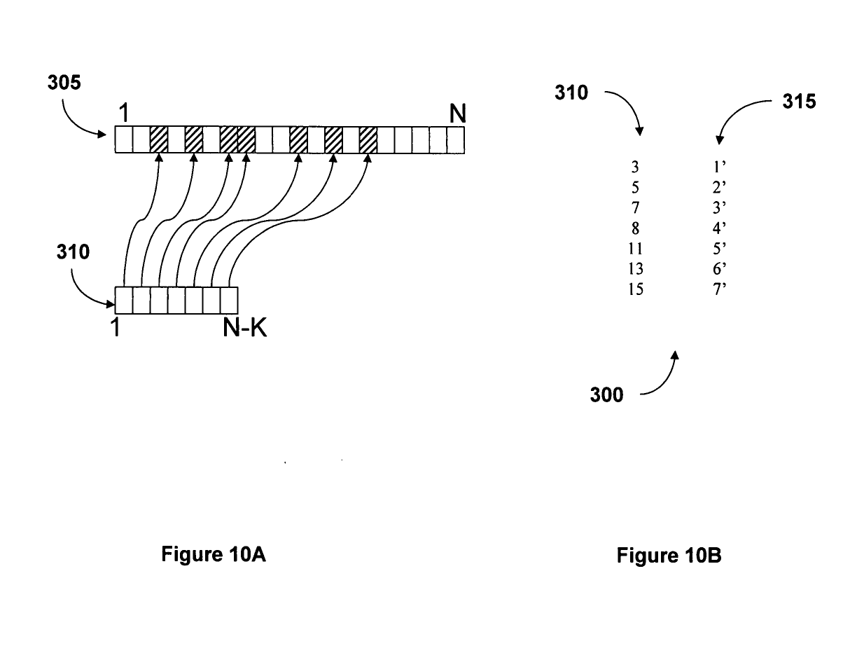

In a fifth embodiment of modifying the current time slot selection, the master 20 generates a mapping matrix 300 that correlates the list of unused time slots 305 to the list of all time slots 310. FIG. 10A is a block diagram of an embodiment showing an exemplary string of all time slots representative of the list of all time slots 305. As used herein, the phrases “string of all time slots” and “list of all time slots” are interchangeable. FIG. 10A is a block diagram of an embodiment showing an exemplary string of unused time slots 310 representative of the list of unused time slots 310. As used herein, the phrases “string of all unused time slots” and “list of all unused time slots” are interchangeable. The list of all time slots 305 has N time slots and each time slot is assigned a numerical value from 1 to N. The interspersed unused time slots, which are master-open time slots, are shown with a cross-hatched fill. The list of unused time slots 310 is shown to include N−K time slots, one for each of the unused time slots in the list of all time slots 305 as illustrated by the connecting arrows. FIG. 10B is a mapping matrix 300 correlating the list of unused time slots 310 to the list of all time slots 305. The first column of the mapping matrix 300 is the numerical value for each of the unused time slot in the list of all time slots 310 as they numerically rank within the list of all time slots 305. The second column is rank order numerical value for the unused time slot in the list of all time slots 310.

In an implementation of this embodiment of modifying the current time slot selection, the first row of the mapping matrix 300 is the numerical value for each of the 7 unused time slots in the list of all time slots 310 as they numerically fall within the list of all time slots 305. The second row is the number 1 through 7, for each of the unused time slots in the list of all time slots 310 as they numerically fall within the list of unused time slots 310.

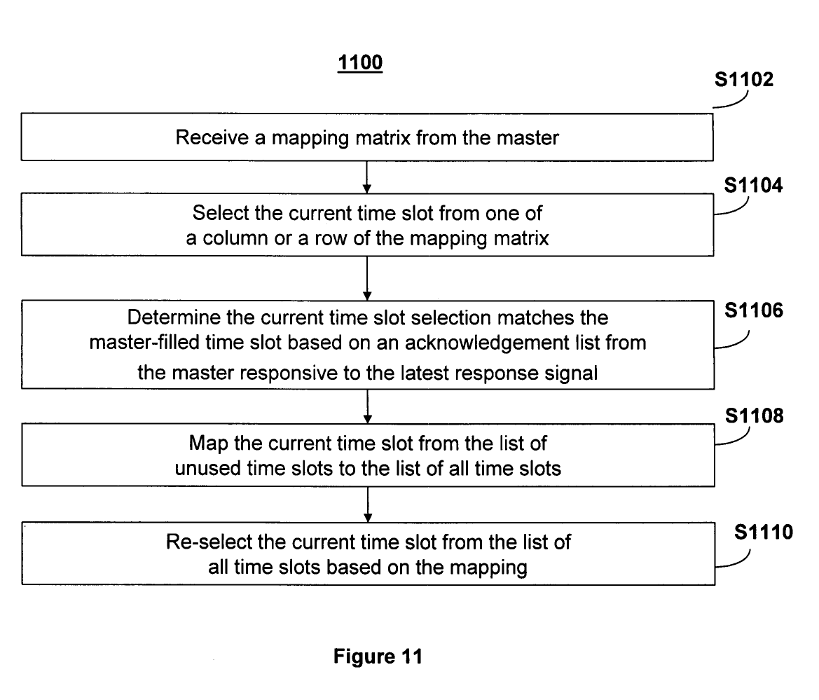

FIG. 11 is a method 1100 of modifying a current time slot selection in accordance with the fifth embodiment of modifying the current time slot selection. During stage S1102, the slaves 31 in the slave population 30 receives a mapping matrix 300 from the master 20. The mapping matrix 300 is included in the acknowledgement list transmitted to the slave population 30.

During stage S1104, each slave 31 selects a current time slot from the second column 315 of the mapping matrix 300 if the slave 31 has a current time slot selection that does not match one of the master-filled time slots in the acknowledgement list. The slaves 31 receive a second interrogation phase command signal 211 from the master 20. The slaves 31 transmit a response signal 212 to the master 20 responsive to the second interrogation phase command signal 211 after waiting the current time interval. The slaves 31 then receive an acknowledgement list from the master 20 responsive to the latest response signal 202. In this case, the second interrogation phase 110 is shorter in duration than the first interrogation phase 100.

In the implementation of the embodiment in which the second row is the numerical value for 1-7 each unused time slot in the list of all time slots 310 the slaves 31 select a current time slot from a row of the mapping matrix 300. In the implementation of this embodiment, the mapping matrix 300 is transmitted after the acknowledgement list.

During stage 1106, the slaves 31 determine the current time slot selection, made from the mapping matrix 300, matches the master-filled time slot based on the acknowledgement list from the master 20 received in response to the latest response signal 202. Thus, the master 21 received the response signal 212 from the slave 31 during the second interrogation phase. In an implementation of this embodiment, the acknowledgement list from the master 20 responsive to the latest response signal 202 also includes a new mapping matrix. This new mapping matrix is used by the slaves 31 which still have not effectively communicated a response to the master 20. In one implementation of this embodiment, the new mapping matrix overrides the first mapping matrix by mapping directly to the list of all time slots. In another implementation of this embodiment, the new mapping matrix maps indirectly to the list of all time slots by mapping to the first mapping matrix.

During stage S1108, the slave 31 maps the current time slot from the list of unused time slots 310 in the second column of mapping matrix 300 to the list of all time slots. The first column of mapping matrix 300 indicates the rank order of the current time slot in the list of all time slots 305. Consider the exemplary slave that has a current time slot of 5. The exemplary slave selected the current time slot of 5 from the second column, fifth row of the mapping matrix. The exemplary slave maps to the list of all time slots 305 by mapping to the first column fifth row of the mapping matrix 300. Other mapping schemes are possible.

During stage S1110, the slave 31 re-selects the current time slot from the list of all time slots 305. The re-selected current time slot is based on the value retrieved from the mapping process of stage S11108. In the case of the exemplary slave with current time slot of 5, the value from the first column fifth row of the mapping matrix 300 becomes the current time slot and the exemplary slave now has a current time slot of 11 for the first interrogation phase 100 of the next interrogation event 130.

Thus, many implementations of the current time slot selection are possible. The current time slot selection is done by at least one of: randomly selecting a new time slot from a list of all time slots; applying a selection algorithm to the list of all time slots; randomly selecting the current time slot from a list of unused time slots; applying a selection algorithm to the list of unused time slots; randomly selecting a time slot from the list of unused time slots and mapping the time slot to the list of all time slots; and applying the selection algorithm to the list of unused time slots and mapping the time slot to the list of all time slots. Other embodiments of methods to modify the current time slot selection are possible as is understandable by those skilled in the art.

During stage S908, the slave 31 sets the affinity value equal to the affinity threshold value as described above with reference to stage S504 of method 500 in FIG. 5. During stage S910 the slave 31 determines the master 20 is not transmitting a second interrogation phase command signal 211 as described above with reference to stage S706 of method 700 in FIG. 7. During stage S912, the slave 31 waits to receive a first interrogation phase command signal 201 from the master 20 as described above with reference to stage S708 of method 700 in FIG. 7.

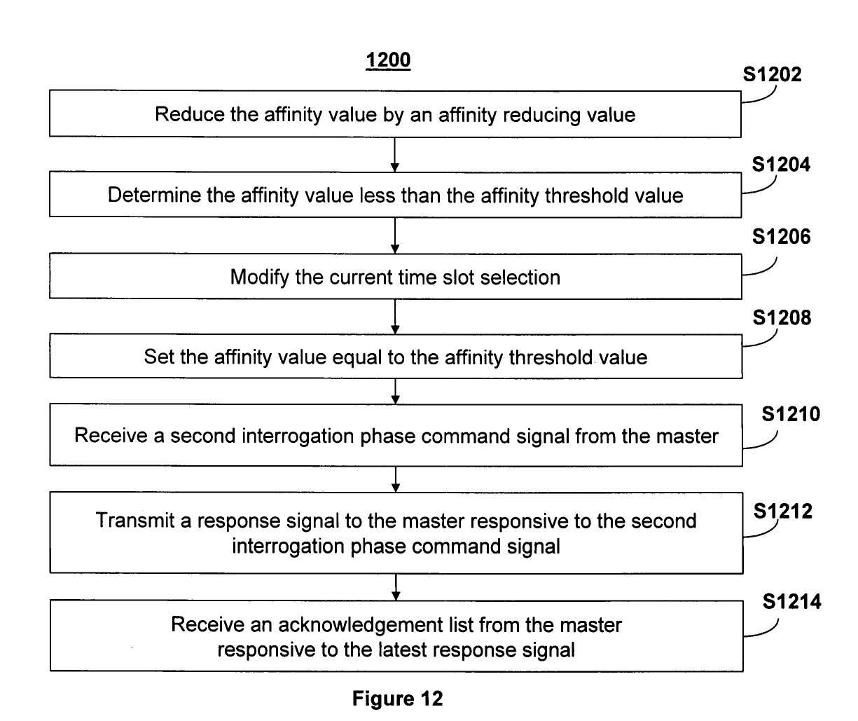

FIG. 12 is a method 1200 of modifying an affinity value in accordance with a fourth embodiment of the present invention. Method 1200 applies to a slave 31 within a master-slave wireless network 10 that requires more than one interrogation phase 100 per interrogation event 130 and which has experienced enough unsuccessful interrogation events 130 to drive the affinity value down to the value equal to the affinity threshold value before the first interrogation phase 100 of the current interrogation event 130. The affinity value is driven to the value of the affinity threshold value as described above with reference to FIG. 9.

During stage S1202, the slave 31 reduces the affinity value by the affinity reducing value. During stage S1204, the slave 31 determines the affinity value is less than the affinity threshold value. In one embodiment of method 1000 as described above, the affinity reducing value is one and the affinity threshold value is one. During stage S11206, the slave 31 modifies the current time slot selection as described above with reference to stage S906 of method 900 in FIG. 9. During stage S1208 the slave 31 sets the affinity value equal to the affinity threshold value.

During stage S1210, the slave 31 receives the second interrogation phase command signal 211 from the master 20. During stage S1212, the slave 31 transmits a response signal 212 to the master 20 responsive to the second interrogation phase command signal 211 after waiting the current time interval.

In one embodiment, the response-received mode of the master 20 in the second interrogation phase command signal is shortened in duration from the first interrogation phase command signal. For example, if the current time slot selection is modified during stage S1206 by random selection of the from the list of all time slots 1 through N, the master 20 does not have a shortened response-received mode. Alternatively, if the current time slot selection is not modified during stage S1206 by random selection from the list of master-open time slots, the master 20 has a shortened response-received mode. In either case, the slaves 31 that were matched to the master-filled time slot acknowledgement list have powered OFF their power sources and do not transmit a response signal 212 to the master 20 during the second interrogation phase 110.

During stage S1214, the slave 31 receives an acknowledgement list from the master 20 responsive to the latest response signal 212 transmitted during stage S11212. The flow of method 1000 continues for a third interrogation phase 120, based the protocol of master-slave wireless network 10 and number of open-master time slots at the master 20 following the second interrogation phase 110. The flows of the third interrogation phase 120 and any additionally required interrogation phases proceed according to the flow of method 1200, as is understandable to one skilled in the art.

Although specific embodiments have been described herein, it will be appreciated by those of skill in the art that other algorithms and protocols for a master-slave wireless network may be substituted for the specific embodiments described. This application is intended to cover any adaptations and variations of the present invention. Therefore it is manifestly intended that this invention be limited only by the claims and the equivalents thereof.

1. A method to dynamically schedule communication between a master and slaves in a variable slave population in a master-slave wireless network, the method comprising:
receiving a first interrogation phase command signal from the master;
transmitting a response signal to the master responsive to the first interrogation phase command signal after a current time interval, the current time interval based on a current time slot selection;
receiving an acknowledgement list from the master responsive to the transmitted response signal;
determining whether the current time slot selection matches a master-filled time slot based on the acknowledgement list; and
modifying an affinity value based on the determination.

2. The method of claim 1, wherein the current time slot selection is an initial time slot selection, the method further comprising:
setting the affinity value equal to an affinity threshold value.

3. The method of claim 2, wherein the affinity threshold value is one.

4. The method of claim 1, wherein modifying the affinity value comprises:
reducing the affinity value if the determination is negative; and
setting the affinity value to a pre-established maximum affinity value if the determination is positive.

5. The method of claim 4, wherein reducing the affinity value comprises:
reducing the affinity value by an affinity reducing value;
determining the affinity value is not less than the affinity threshold value;
determining the master is not transmitting a second interrogation phase command signal; and
waiting to receive the first interrogation phase command signal from the master.

6. The method of claim 4, wherein reducing the affinity comprises:
reducing the affinity value by an affinity reducing value;
determining the affinity value is not less than an affinity threshold value;
receiving a second interrogation phase command signal from the master;
transmitting a response signal to the master responsive to the second interrogation phase command signal; and
receiving an acknowledgement list from the master responsive to the latest response signal.

7. The method of claim 6, wherein a duration of a second interrogation phase is shorter than a duration of a first interrogation phase.

8. The method of claim 4, wherein reducing the affinity value comprises:
reducing the affinity value by an affinity reducing value determining the affinity value is less than an affinity threshold value;
modifying the current time slot selection;
setting the affinity value equal to the affinity threshold value;
determining the master is not transmitting a second interrogation phase command signal; and
waiting to receive the first interrogation phase command signal from the master.

9. The method of claim 8, wherein a duration of a second interrogation phase is shorter than a duration of a first interrogation phase.

10. The method of claim 9, wherein receiving an acknowledgement list from the master responsive to the transmitted response signal comprises:
receiving a mapping matrix from the master, wherein the mapping matrix correlates a list of unused time slots to a list of all time slots, and wherein the duration of the second interrogation phase is correlated to the list of unused time slots;
selecting the current time slot from one of a column or a row of the mapping matrix;
determining the current time slot selection matches the master-filled time slot based on an acknowledgement list from the master responsive to the latest response signal;
mapping the current time slot to the list of all time slots; and
selecting the current time slot from the list of all time slots based on the mapping.

11. The method of claim 8, wherein modifying the current time slot selection is selected from the group comprising at least one of: randomly selecting a new time slot from a list of all time slots; applying a selection algorithm to the list of all time slots; randomly selecting the current time slot from a list of unused time slots; applying a selection algorithm to the list of unused time slots; randomly selecting a time slot from the list of unused time slots and mapping the time slot to the list of all time slots; and applying the selection algorithm to the list of unused time slots and mapping the time slot to the list of all time slots.

12. The method of claim 4, wherein reducing the affinity value comprises:
reducing the affinity value by an affinity reducing value;
determining the affinity value is less than an affinity threshold value;
modifying the current time slot selection;
setting the affinity value equal to the affinity threshold value;
receiving a second interrogation phase command signal from the master;
transmitting a response signal to the master responsive to the second interrogation phase command signal after the current time interval; and
receiving an acknowledgement list from the master responsive to the latest response signal.

13. The method of claim 12, wherein a duration of a second interrogation phase is shorter than a duration of a first interrogation phase.

14. The method of claim 13, receiving an acknowledgement list from the master responsive to the transmitted response signal comprises:
receiving a mapping matrix from the master, wherein the mapping matrix correlates a list of unused time slots to a list of all time slots, and wherein the duration of the second interrogation phase is correlated to the list of unused time slots;
selecting the current time slot from one of a column or a row of the mapping matrix;
determining the current time slot selection matches the master-filled time slot based on an acknowledgement list from the master responsive to the latest response signal;
mapping the current time slot from the list of unused time slots to the list of all time slots; and
selecting the current time slot from the list of all time slots based on the mapping.

15. The method of claim 12, wherein modifying the current time slot selection is selected from the group comprising: at least one of randomly selecting the current time slot selection from a list of all time slots; applying a selection algorithm to the list of all time slots; randomly selecting the current time slot selection from a list of unused time slots; applying a selection algorithm to the list of unused time slots; randomly selecting a time slot from the list of unused time slots and mapping the time slot to the list of all time slots; and applying a selection algorithm to the list of unused time slots and mapping the time slot to the list of all time slots.

16. The method of claim 1, wherein the master is a radio frequency identification reader and the slave is a radio frequency identification tag.

17. The method of claim 1, wherein the acknowledgement list is selected from the group comprising at least one of a list of master-filled time slots, a list of master-open time slots, a list of receive-failed time slots, a list of master-contended time slots, a list of master-quiet time slots.

18. The method of claim 1, wherein the first interrogation phase command signal initiates a first interrogation phase in an interrogation event and a second interrogation phase command signal initiates a second interrogation phase in the interrogation event, and wherein the second interrogation phase is of shorter duration than the first interrogation phase.

19. The method of claim 18, wherein subsequent interrogations phases follow the second interrogation phase until the all time slots in an acknowledgment list are master-filled time slots, and wherein each subsequent interrogation phase is of shorter duration than the previous interrogation phase.

20. A system to dynamically schedule communication between a master and a slave in a variable slave population in a master-slave wireless network, comprising:
means for determining an initial time slot selection for the slave;
means for establishing an affinity value for the slave;
means for establishing a current time slot selection for the slave; and
means for dynamically re-establishing the affinity value and the current time slot selections for the slave as the slave population changes.

21. The system of claim 20, the system further comprising:
means for mapping a list of unused time slots to a list of all time slots; and
means for modifying a current time slot selection based on the mapping.

22. A computer readable medium storing a computer program comprising:
computer readable code for receiving a first interrogation phase command signal from the master;
computer readable code for transmitting a response signal to the master after a current time interval;
computer readable code for receiving an acknowledgement list from the master;
computer readable code for determining whether the current time slot selection matches a master-filled time slot; and
computer readable code for modifying an affinity value based on the determination.

23. The medium of claim 22, further comprising:
computer readable code for generating a mapping matrix wherein the mapping matrix correlates a list of unused time slots to a list of all time slots;
computer readable code for selecting the current time slot from one of a column or a row of the mapping matrix;
computer readable code for determining the current time slot selection matches the master-filled time slot based on an acknowledgement list from the master responsive to the latest response signal;
computer readable code for mapping the current time slot from the list of unused time slots to the list of all time slots; and
computer readable code for selecting the current time slot from the list of all time slots based on the mapping.

24. The medium of claim 22, wherein the current time slot is an initial time slot selection, the medium further comprising:
setting the affinity value equal to an affinity threshold value.

25. The medium of claim 22, wherein computer readable code for modifying the affinity value comprises:
computer readable code for reducing the affinity value if the determination is negative; and
computer readable code for setting the affinity value to a pre-established maximum affinity value if the determination is positive.

26. The medium of claim 25, wherein computer readable code for reducing the affinity value comprises:
computer readable code for reducing the affinity value by an affinity reducing value;
computer readable code for determining the affinity value is not less than an affinity threshold value;
computer readable code for determining the master is not transmitting a second interrogation phase command signal; and
computer readable code for waiting to receive a first interrogation phase command signal from the master.

27. The method of claim 25, wherein computer readable code for reducing the affinity value comprises:
computer readable code for reducing the affinity value by an affinity reducing value;
computer readable code for determining the affinity value is not less than an affinity threshold value;
computer readable code for receiving a second interrogation phase command signal from the master;
computer readable code for transmitting a response signal to the master responsive to the second interrogation phase command signal; and
computer readable code for receiving an acknowledgement list from the master responsive to the latest response signal.

28. The medium of claim 25, wherein computer readable code for reducing the affinity value comprises:
computer readable code for reducing the affinity value by an affinity reducing value;
computer readable code for determining the affinity value is less than an affinity threshold value;
computer readable code for modifying the current time slot selection;
computer readable code for setting the affinity value equal to the affinity threshold value;
computer readable code for determining the master is not transmitting a second interrogation phase command signal; and
computer readable code for waiting to receive a first interrogation phase command signal from the master.

29. The medium of claim 25, wherein computer readable code for reducing the affinity value comprises:
computer readable code for reducing the affinity value by an affinity reducing value;
computer readable code for determining the affinity value is less than an affinity threshold value;
computer readable code for modifying the current time slot selection;
computer readable code for setting the affinity value equal to the affinity threshold value;
computer readable code for receiving a second interrogation phase command signal from the master;
computer readable code for transmitting a response signal to the master responsive to the second interrogation phase command signal; and
computer readable code for receiving an acknowledgement list from the master responsive to the latest response signal.
